(19) United States
(12) Patent Application Publication
(10) Pub. No.: US 2018/0082333 A1
(43) Pub. Date: Mar. 22, 2018

(54) PROMOTIONAL CAMPAIGNS WITH CUSTOMIZED ACTIVE PERIODS BASED ON USER DEVICE LOCATION TRENDS

(71) Applicant: INTERNATIONAL BUSINESS MACHINES CORPORATION, Armonk, NY (US)

(72) Inventors: Jeremy A. Greenberger, Raleigh, NC (US); Zachary M. Greenberger, Raleigh, NC (US)

(21) Appl. No.: 15/270,362

(22) Filed: Sep. 20, 2016

(51) Int. Cl. G06Q 30/02; H04W 4/02; H04W 4/20

(52) U.S. Cl. CPC G06Q 30/0261; H04W 4/028; G06Q 30/0267; H04W 4/021; H04W 4/206

(57) ABSTRACT

A computer-implemented method includes: receiving, by a computing device, user device location information for a plurality of user devices; storing, by the computing device, location history for the plurality of user devices corresponding to the user device location information; receiving, by the computing device, campaign criteria in connection with offering a campaign to one or more of the plurality of user devices; determining, by the computing device, active time periods for each the one or more of the plurality of user devices based on the stored location history for the one or more of the plurality of user devices and the campaign criteria; and providing, by the computing device, respective notifications regarding the campaign to each of the one or more of the plurality of user devices based on the determining the active time periods, wherein each of the respective notifications identify a respective active time period.

### BACKGROUND

The present invention generally relates to implementing promotional campaigns and, more particularly, to customizing active time periods for promotional campaigns for individual users based on location trends of individual user devices.

A promotional campaign is an event or period of time in which promotions (e.g., discounts, sales, etc.) may be offered to potential customers. Registered users and/or customers may be notified of promotional campaigns via user devices (e.g., smart phones, tablets, etc.). Merchants may implement promotional campaigns to improve sales or notify users of promotional events for which a user may be interested. Promotional campaigns may be active for a period of time in which promotions are in effect (e.g., time periods in which discounts are offered to customers).

### SUMMARY

In an aspect of the invention, a computer-implemented method includes: receiving, by a computing device, user device location information for a plurality of user devices; storing, by the computing device, location history for the plurality of user devices corresponding to the user device location information; receiving, by the computing device, campaign criteria in connection with offering a campaign to one or more of the plurality of user devices; determining, by the computing device, active time periods for each the one or more of the plurality of user devices based on the stored location history for the one or more of the plurality of user devices and the campaign criteria; and providing, by the computing device, respective notifications regarding the campaign to each of the one or more of the plurality of user devices based on the determining the active time periods, wherein each of the respective notifications identify a respective active time period.

In an aspect of the invention, there is a computer program product for establishing different active periods for a single campaign offered to a plurality of users. The computer program product includes a computer readable storage medium having program instructions embodied therewith, the program instructions executable by a computing device to cause the computing device to: monitor user device location information for a plurality of user devices while the plurality of user devices are located within a defined boundary; determine location history for the plurality of user devices based on monitoring the user device location information; receive campaign criteria in connection with offering a campaign to one or more of the plurality of user devices; determine active time periods for each the one or more of the plurality of user devices based determining the location history for the one or more of the plurality of user devices and the campaign criteria; and provide respective notifications regarding the campaign to each of the one or more of the plurality of user devices based on the determining the active time periods, wherein each of the respective notifications identify a respective active time period.

In an aspect of the invention, a system includes: a CPU, a computer readable memory and a computer readable storage medium associated with a computing device; program instructions to monitor user device location information for a plurality of user devices while the plurality of user devices are located within a defined boundary; program instructions to generate data records identifying the location history for the plurality of user devices based on monitoring the user device location information; program instructions to receive campaign criteria in connection with offering a campaign to one or more of the plurality of user devices; program instructions to determine active time periods for each the one or more of the plurality of user devices based on the data records identifying the location history for the one or more of the plurality of user devices and the campaign criteria; and program instructions to providing respective notifications regarding the campaign to each of the one or more of the plurality of user devices based on the determining the active time periods, wherein each of the respective notifications identify a respective active time period. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example implementation in accordance with aspects of the present invention

FIG. 5 shows an example environment in accordance with aspects of the present invention.

FIG. 6 shows a block diagram of example components of a promotional campaign management server in accordance with aspects of the present invention.

FIG. 7 shows an example flowchart for determining campaign active periods for each user device and providing user devices with notifications regarding a campaign in accordance with aspects of the present invention.

FIGS. 8A and 8B show example graphs that may be used to determine custom active time periods of a campaign offered to different users in accordance with aspects of the present invention.

### DETAILED DESCRIPTION

The present invention generally relates to implementing promotional campaigns and, more particularly, to customizing active time periods for promotional campaigns for individual users based on location trends of individual user devices. Aspects of the present invention may monitor the location history of user devices within a facility (e.g., a merchant facility, a store, or the like), and may generate promotional campaigns with different time periods for individual users based on the user device location history. That is, a same promotional campaign may be active for different periods of times for different users. For example, for one user, a promotional campaign may be active (e.g., discounts may be offered) during one period of time, whereas for another user, the same promotional campaign may be active for a different period of time.

As described herein, the active period may be based on user device location history and/or patterns. As an example, the active period may correspond to a time period during which the user typically does not visit the facility (e.g., to encourage the user to visit the facility at a time in which the user does not typically visit). Alternatively, the active period may correspond to a time period during which the user typically visits the facility (e.g., to provide the user with promotions in anticipation of the user visiting the facility). Thus, the active period for a promotional campaign may differ between users having different location histories and/or patterns. As described herein, users may receive notifications via user devices regarding the promotional campaign, including the active period (e.g., start and end times) for the ad campaign.

As described herein, location determination devices (e.g., beacons, wireless networking devices, etc.) may be used to determine the location of user devices within a facility (e.g., a merchant facility, a store, etc.) and to establish patterns for when a user typically visits the facility. Advantageously, promotional campaigns may better align with a user's location history, patterns, and habits in order to better serve the user. Further, sales may be increased by encouraging the user to visit the merchant facility at times when the user typically does not visit the merchant facility. That is, the effectiveness of promotional campaigns may be improved by customizing the active periods for the promotional campaigns on an individualized basis.

Aspects of the present invention may improve the effectiveness of each campaign that is provided to a user. Accordingly, fewer campaigns may be provided. In this way, computing resource usage, CPU usage/processing, power consumption, network activity and congestion, etc. may be reduced and conserved. For example, resource consumption for a user device may be reduced in that the number of campaigns being monitored and received may be reduced as campaigns may be only be provided at the most effective times for the user. Similarly, resource consumption for a campaign management system may be reduced as fewer campaigns are provided to the user device at more effective times. In other words, the effectiveness of each campaign may be improved, thereby reducing the needed quantity of campaigns and, in turn, conserving computing and/or network resources. In some scenarios, the conserved resources are utilized to provide campaigns to additional users such that the total number of users that are supported by a given set of computing and/or network resources is increased. This increase in the total number of users that are supported may be seen as in an increase in the overall capacity of the computing system that provides the computing and/or network resources. In some scenarios a set amount of computing and/or network resources are reserved such that unexpected increases in demand for computing and/or network resources can be accommodated without loss of service to the users, i.e., the users continue to receive the campaigns as described. This may result in an increase in the overall stability and robustness of the computing system that provides the computing and/or network resources.

While aspects of the present invention may track the location of user devices, location tracking may occur on an “opt-in” basis in which a user provides explicit permission for location to be tracked within a merchant facility. Further, location tracking may be implemented in accordance with applicable privacy laws and may be discontinued at any time for users who have revoked permission for location tracking.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

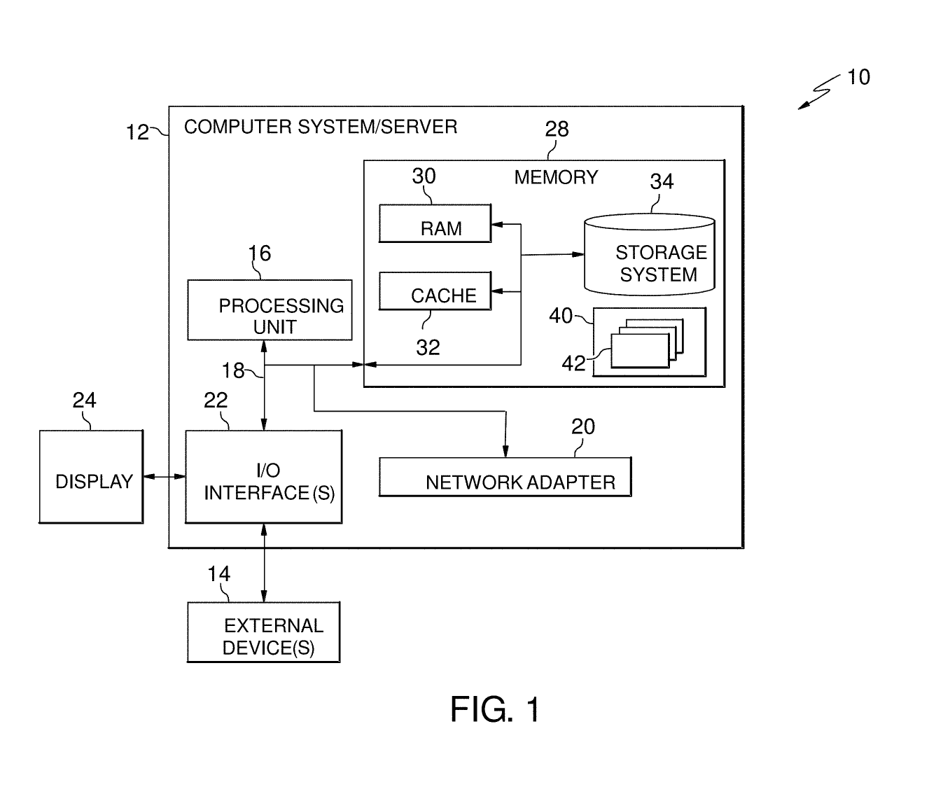

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

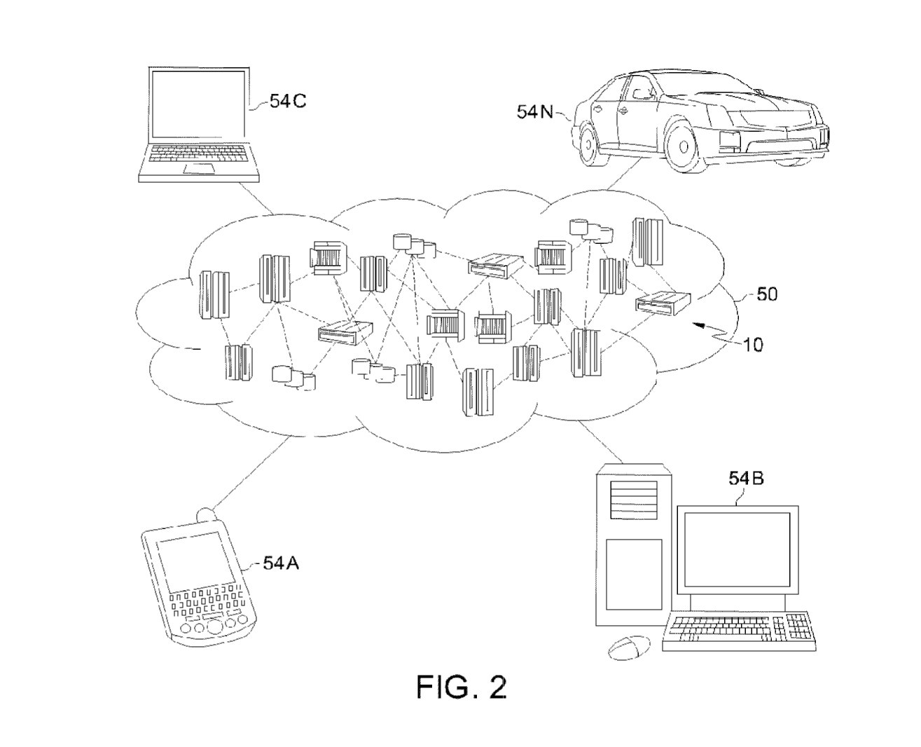

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

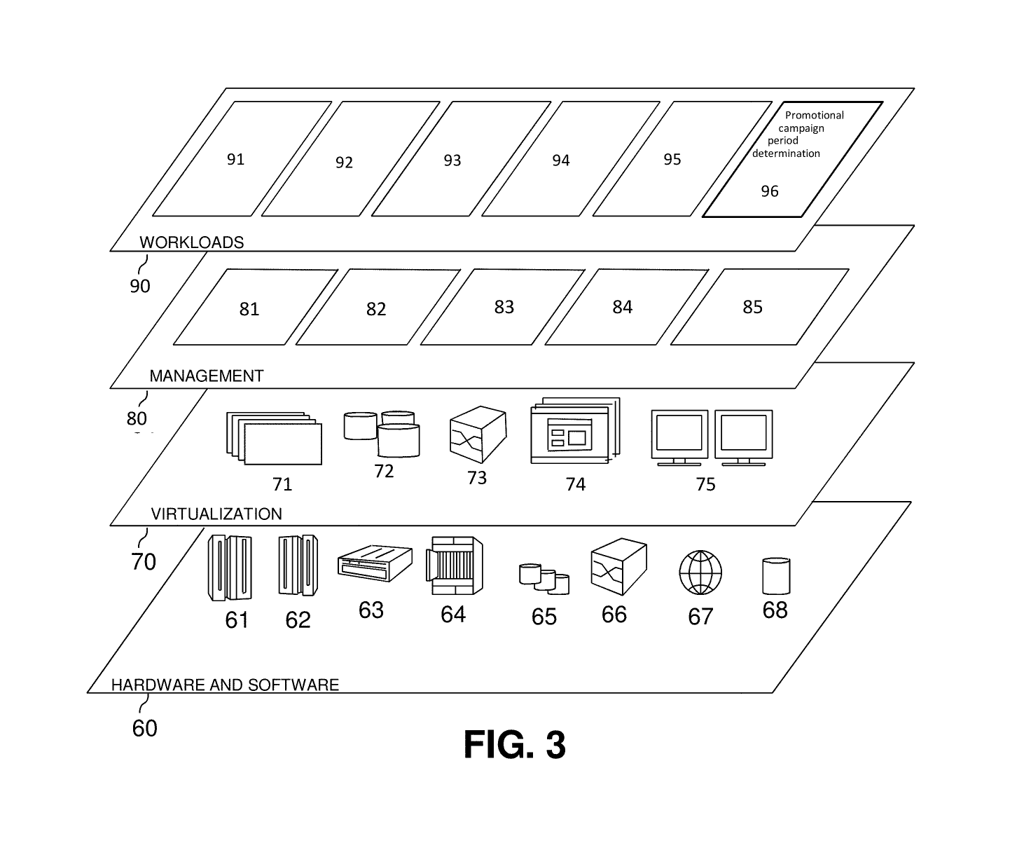

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and promotional campaign period determination 96.

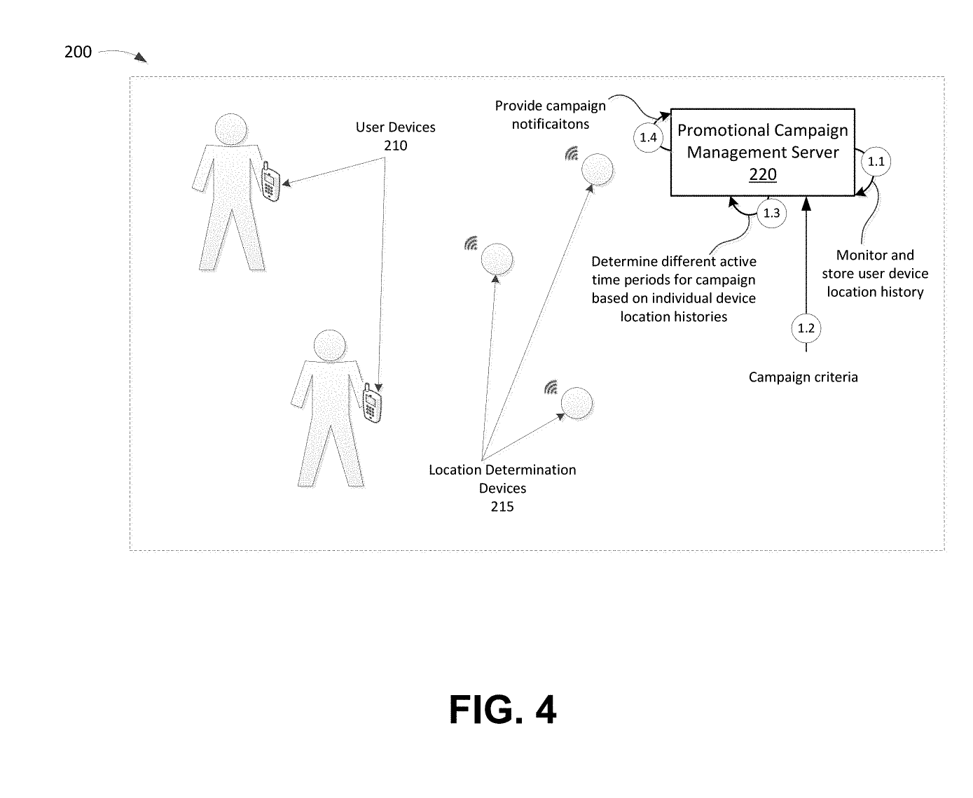

Referring back to FIG. 1, the program/utility 40 may include one or more program modules 42 that generally carry out the functions and/or methodologies of embodiments of the invention as described herein (e.g., such as the functionality provided by promotional campaign period determination 96). Specifically, the program modules 42 may store user device location history, receive promotional campaign criteria, determine active periods for promotional campaign on an individual user basis, and provide a notification regarding the promotional campaign to user devices. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of promotional campaign management server 220 as shown in FIG. 4.

FIG. 4 shows an overview of an example implementation in accordance with aspects of the present invention. As shown in FIG. 4, a promotional campaign management server 220 may be implemented within a boundary 200 (e.g., a venue, a merchant facility, or the like). As users with user devices 210 move within the boundary 200, location determination devices 215 may be used to determine the location of the user devices 210 while the user devices 210 are located within the boundary 200. The promotional campaign management server 220 may monitor and store user device location history within the boundary 200 using the location determination devices 215 (step 1.1). For example, the promotional campaign management server 220 may store data records indicating time periods when user devices were located within the boundary 200. Over a period of time, the location history of individual user devices 210 may be used to determine location and activity trends on an individual user device basis. For example, the promotional campaign management server 220 may determine that a particular user associated with a particular user device 210 typically visits the merchant facility corresponding to boundary 200 on weekends from 10 AM to 12 PM.

As further shown in FIG. 4, the promotional campaign management server 220 may receive campaign criteria (at step 1.2). For example, the promotional campaign management server 220 may receive the campaign criteria from an administrator in order to establish a promotional campaign to be offered to users (e.g., an offer for discounts on merchandise, or the like). In embodiments, the campaign criteria may be used to define the active time periods for when the same campaign is active for different user devices based 210 on the location history of the different user devices 210. As an example, the campaign criteria may specify that a campaign should be active during the user's least visited times within a specified date/time range. As another example, the campaign criteria may specify that a campaign should be active during times when the user has visited the merchant facility a threshold minimum or maximum number of times, or for a threshold minimum/maximum amount of time within a specified date/time range. As another example, the campaign criteria may specify that a campaign should be active for directed shoppers during one date/time range, and to non-directed shoppers during a different date/time range. As another example, the campaign criteria may specify that a campaign should not be active at all for certain users (e.g., who have not visited the merchant facility for a threshold period of time). As another example, the campaign criteria may specify that a campaign should be active for users who have visited a particular section of the merchant facility a threshold number of times within a specified date/time range.

As further shown in FIG. 4, the promotional campaign management server 220 may determine different active time periods for the campaign based on individual device location histories (step 1.3). As an example, assume that the campaign criteria specifies that a campaign should be active during the least visited times within a specified date/time range. Further, assume that a first user device 210, the least visited times were from Monday-Wednesday of a given week, and that for a second user device 210, the least visited times were from Friday-Saturday of a given week. Given these assumptions, the promotional campaign management server 220 may determine an active time period for the first user device 210 from Monday-Wednesday, and an active time period for the second user device 210 from Friday-Saturday. At step 1.4, the user device 210 may provide notifications regarding the campaign to the user devices 210. In embodiments, each notification to each individual user device 210 may identify the corresponding custom active time period. In embodiments the notifications may be sent at a set time before the start of the active time period, or may all be sent at the same time (e.g., the beginning of the day, week, month, etc.). In this way, different users associated with different user devices 210 may receive promotional campaigns with more effective active dates that are based on the location history of the user devices 210.

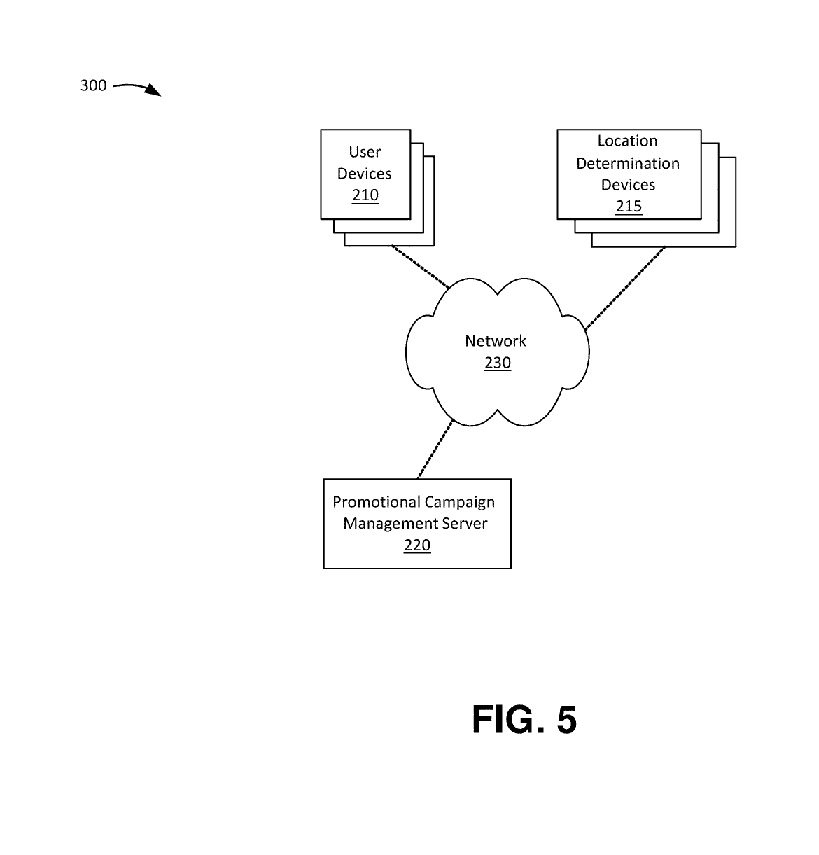

FIG. 5 shows an example environment in accordance with aspects of the present invention. As shown in FIG, 5, environment 300 may include user devices 210 (referred to individually as “user device 210” and collectively as “user devices 210”), location determination devices 215, promotional campaign management server 220, and/or network 230. In embodiments, one or more components in environment 400 may correspond to one or more components in the cloud computing environment of FIG. 2.

The user devices 210 may each include a device capable of communicating via a network, such as the network 230. For example, the user devices 210 may each correspond to a mobile communication device (e.g., a smart phone or a personal digital assistant (PDA)), a portable computer device (e.g., a laptop or a tablet computer), or another type of device.

The location determination devices 215 may include one or more computing devices, such as beacons, network devices, or the like that may connect with the user device 210 via, for example, a wireless local area network (WLAN), a wireless personal area network (WPAN), or the like. Additionally, or alternatively, the location determination devices 215 may receive broadcast or discovery signals transmitted by the user device 210 without establishing a connection with the user device 210. The location determination devices 215 may provide information regarding the location of user devices 210 to the promotional campaign management server 220. For example, each location determination device 215 may provide information regarding their own locations and signal strength information of a signal received from the user device 210. As described herein, the location determination device 215 may provide identification information for the user device 210 (e.g., a Media Access Control (MAC) address of the user device 210, a device identifier, or the like). The location determination devices 215 may be located in a particular location associated with a service provider or merchant that seeks to establish different active time periods for campaigns provided to users of user devices 210. Additionally, or alternatively, the location determination devices 215 may transmit signals that carry respective identifiers of the location determination devices 215. When a user device 210 is within communications range of a location determination device 215, the user device 210 may receive the identifier of the location determination device 215, and output the identifier to the promotional campaign management server 220. The promotional campaign management server 220 may then determine the location of the user device 210 based on the received identifier and the known location of the location determination device 215 associated with the identifier.

In embodiments, a merchant facility may implement one or more location determination devices 215 to determine the location of user devices 210 while the user devices 210 are located within the merchant facility (or a section within the merchant facility, such as a particular department of the merchant facility). The location determination devices 215 may be arranged such that communications range of the location determination devices 215 corresponds to a defined boundary (e.g., a boundary corresponding to a merchant facility or a boundary of a section of a merchant facility). In embodiments, communications blocking or shaping techniques may be used such that the communications range of the location determination devices 215 corresponds to a desired boundary. For example, wall papers, paints, and/or other techniques may be implemented within the merchant facility to prevent the communications range from exceeding a boundary. In this way, monitoring of user device 210 location may only occur while the user device 210 is located within the merchant facility.

The promotional campaign management server 220 may include one or more computing devices that may monitor and store location history for user devices 210. As described herein, the promotional campaign management server 220 may monitor and store the location history by utilizing the location determination devices 215. In embodiments, the promotional campaign management server 220 may determine different active time periods for the same promotional campaign based on the location history of different user devices 210.

The network 230 may include network nodes, such as network nodes 10 of FIG. 2. Additionally, or alternatively, the network 230 may include one or more wired and/or wireless networks. For example, the network 230 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 230 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 300 is not limited to what is shown in FIG. 5. In practice, the environment 300 may include additional devices and/or networks; fewer devices and/or networks; different devices and/or networks; or differently arranged devices and/or networks than illustrated in FIG. 5. Also, in some implementations, one or more of the devices of the environment 300 may perform one or more functions described as being performed by another one or more of the devices of the environment 2300. Devices of the environment 300 may interconnect via wired connections, wireless connections, or a combination of wired and wireless connections.

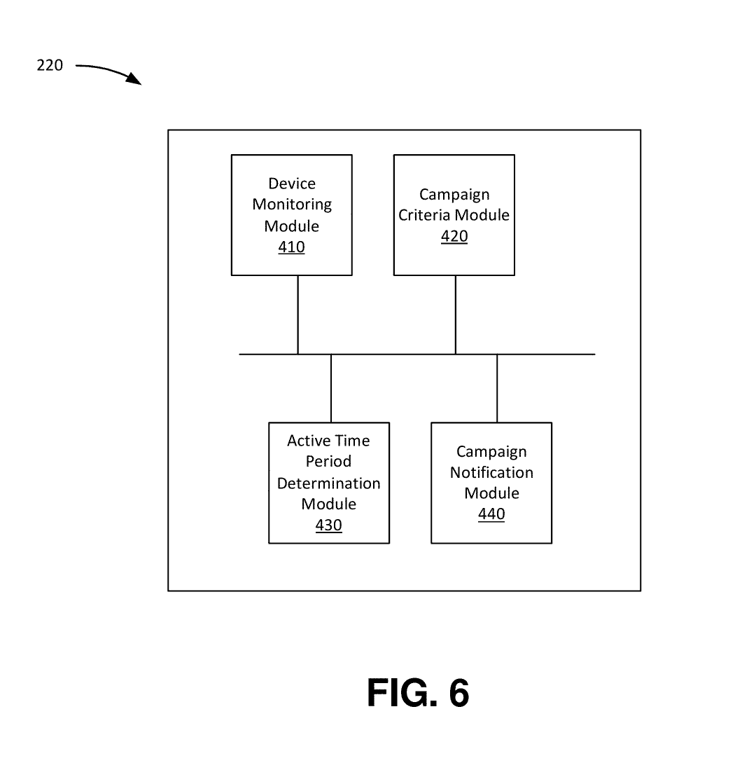

FIG. 6 shows a block diagram of example components of a promotional campaign management server 220 in accordance with aspects of the present invention. As shown in FIG. 6, the promotional campaign management server 220 may include a device monitoring module 410, a campaign criteria module 420, an active time period determination module 430, and a campaign notification module 440. In embodiments, the promotional campaign management server 220 may include additional or fewer components than those shown in FIG. 6. In embodiments, separate components may be integrated into a single computing component or module. Additionally, or alternatively, a single component may be implemented as multiple computing components or modules.

The device monitoring module 410 may include a program module (e.g., program module 42 of FIG. 1) that receives location information for user devices 210 (e.g., using the location determination devices 215). The device monitoring module 410 may generate data records identifying time periods when user devices 210 were located within a particular facility or boundary (e.g., section of a facility). Additionally, or alternatively, the device monitoring module 410 may generate data records identifying time periods for when user device 210 was located within a particular range of longitude/latitude coordinates (e.g., coordinates corresponding to the location of a merchant facility or section of a merchant facility). The device monitoring module 410 may provide the data records for storage (e.g., in a storage system 34 of FIG. 1).

In embodiments, the device monitoring module 410 may receive information indicating the location of a user device 210 when the user device 210 enters the merchant facility or a particular section of the merchant facility. More specifically, the device monitoring module 410 may receive information indicating the location of a user device 210 when the user device 210 locates to within a communications range of location determination devices 215 (e.g., a range corresponding to a defined boundary, such as the location of a merchant facility or a section of the merchant facility). Fine location techniques may be used to determine and track the location of the user device 210 using the location determination devices 215, and device monitoring module 410 may store data records for the user device 210 identifying times and locations of the user device 210 based on the received location information. In this way, the device monitoring module 410 may monitor the location of the user device 210 when the user device 210 is located within the merchant facility (e.g., a within a boundary defining a communications range of the location determination devices 215 in which the boundary corresponds to the boundary of the merchant facility). When the user device 210 exists the facility (e.g., exits the communications range of the location determination devices 215), the device monitoring module 410 may discontinue monitoring the location of the user device 210. When the user device 210 later comes back to within the communications range of the location determination devices 215 (e.g., back to the merchant facility), the device monitoring module 410 may resume monitoring of the user device 210.

The campaign criteria module 420 may include a program module (e.g.. program module 42 of FIG. 1) that receives campaign criteria (e.g., from an administrator). In embodiments, the campaign criteria module 420 may receive the campaign criteria as part of an instruction to establish a campaign with different active dates for different users. As described herein, the campaign criteria may include the campaign itself (e.g., an advertisement for discounts, a printable or electronic coupon, etc.), identification of a target audience (e.g., direct vs. non-direct shoppers, users in a particular demographic group, all users, etc.), and parameters that may be used to define different active time periods for a same campaign based on the location history of different user devices 210. In embodiments, the campaign criteria may include a minimum/maximum threshold number of visits to a merchant facility (or section of the merchant facility), a minimum/maximum threshold number amount of time spent at a merchant facility (or section of the merchant facility), a date/time range, or the like. Also, the campaign criteria may specify a minimum active time period for the campaign, as is described in greater detail herein.

The active time period determination module 430 may include a program module (e.g., program module 42 of FIG. 1) that determines the active time periods in which a campaign is active for different user devices 210 based on the location history of the user devices 210. For example, the active time period determination module 430 may determine user devices 210 associated with users in the targeted audience specified in the campaign criteria. The active time period determination module 430 may analyze the historical location data records for each user device 210 in the targeted audience, and determine the active time periods (subject to a minimum active time period if specified) for each user device 210 in the targeted audience based on the historical location data records.

As an example, assume that the campaign criteria specifies that a campaign should be active within a one-week period on days of the week when users have visited a particular section of a merchant facility (e.g., a shoe department) an average of less than 1 time. Further, assume that a user of a first user device 210 visited the shoe department less than 1 time from Monday-Wednesday, and that for a user of a second user device 210 visited the shoe department less than 1 time from Friday-Saturday. Given these assumptions, the active time period determination module 430 may determine an active time period for the first user device 210 from Monday-Wednesday, and an active time period for the second user device 210 from Friday-Saturday. Continuing with the above example, assume that the campaign criteria specifies a minimum period of three days. Given this assumption, the active time period determination module 430 may determine an active time period for the first user device 210 from Monday-Thursday and an active time period for the second user device 210 from Friday-Sunday (e.g., to meet the minimum active period of three days).

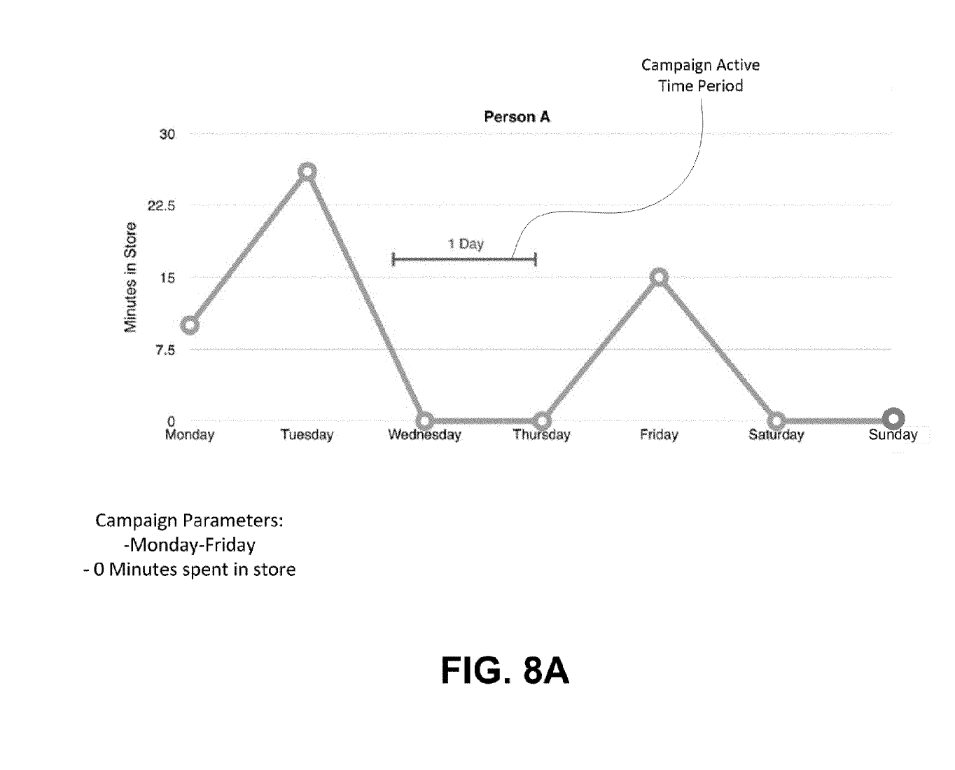

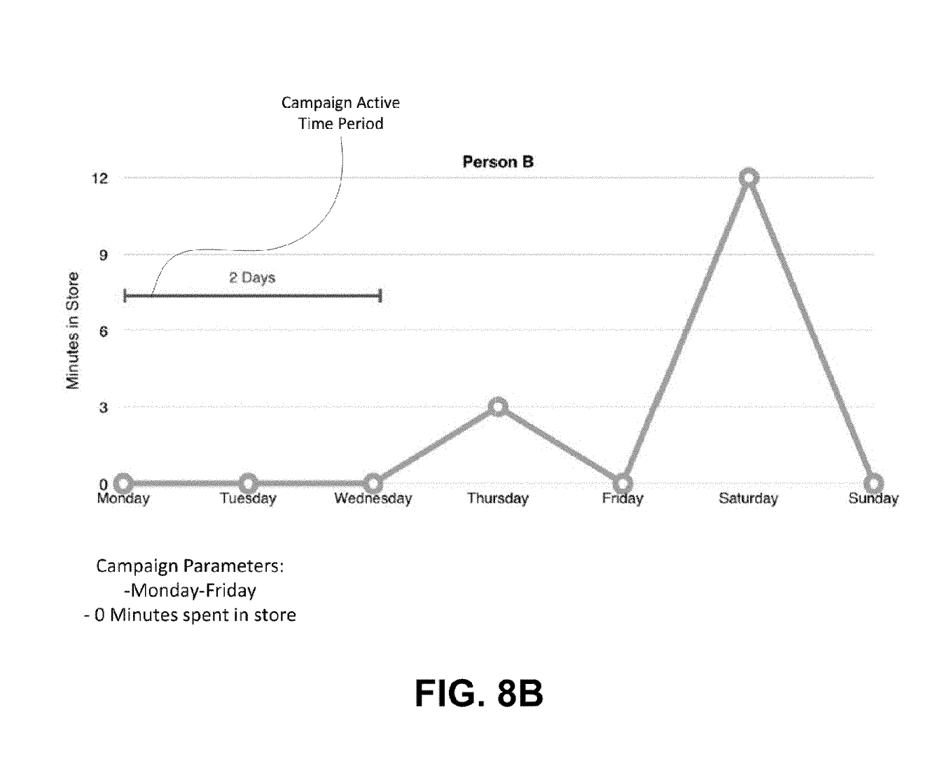

In embodiments, and as described in greater detail below with respect to FIGS. 8A and 8B, the active time period determination module 430 may generate a graph that represents the amount of time a user spent at a merchant facility during different days in the week. The graph may be generated based on the location records for the user device 210 associated with the user. The graph may be used to determine the active time periods of a campaign for different users.

The campaign notification module 440 may include a program module (e.g., program module 42 of FIG. 1) that provides notifications regarding campaigns to the user devices 210. For example, the campaign notification module 440 may provide the notifications to the targeted user devices 210 (e.g., the targeted user devices 210 identified by the campaign criteria). In embodiments, each notification to each individual user device 210 may identify the corresponding custom active time period. In embodiments the notifications may be sent at a set time before the start of the active time period, or may all be sent at the same time (e.g., the beginning of the day, week, month, etc.). In this way, different users associated with different user devices 210 may receive promotional campaigns with more effective active dates that are based on the location history of the user devices 210. In embodiments, the notification may be displayed by the user device 210 (e.g., as a pop-up notification, text notification, e-mail notification, and/or other type of notification). In embodiments, the notification may include the campaign itself (e.g., a promotional advertisement, a printable and/or electronic coupon, or the like). Additionally, or alternatively, the notification may include a link to the campaign.

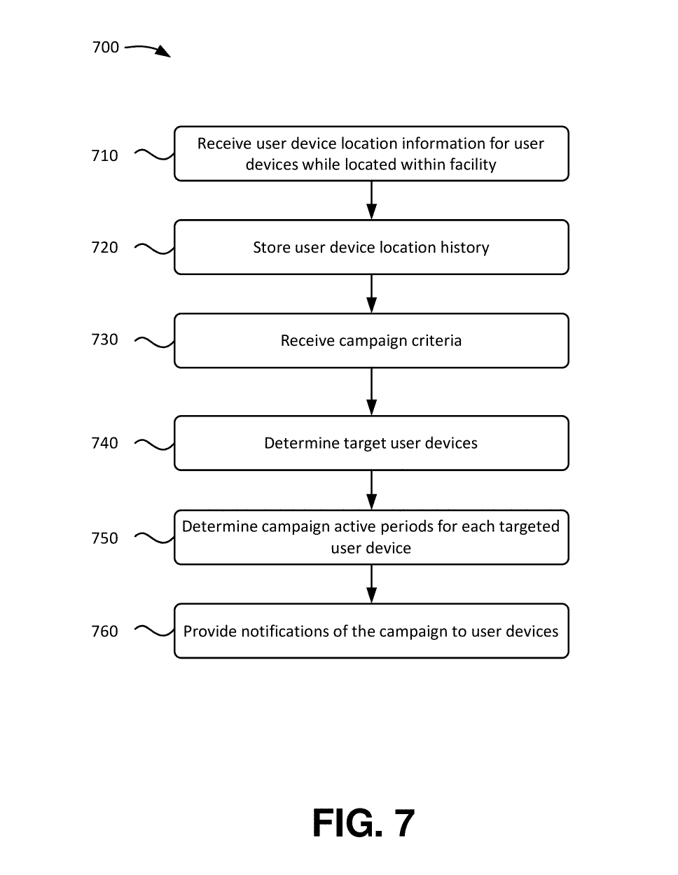

FIG. 7 shows an example flowchart for determining campaign active periods for each user device and providing user devices with notifications regarding a campaign. The steps of FIG. 7 may be implemented in the environment of FIG. 4, for example, and are described using reference numbers of elements depicted in FIG. 4. As noted above, the flowchart illustrates the architecture, functionality, and operation of possible implementations of systems, methods, and computer program products according to various embodiments of the present invention.

As shown in FIG. 7, process 700 may include receiving user device location information for user devices while located within a facility (step 710). For example, as described above with respect to the device monitoring module 410, the promotional campaign management server 220 may receive location information for user devices 210 (e.g., using the location determination devices 215).

Process 700 may further include storing user device location history (step 720). For example, as described above with respect to the device monitoring module 410, the promotional campaign management server 220 may store data records identifying time periods when user devices 210 were located within a particular facility or boundary (e.g., section of a facility). Additionally, or alternatively, the promotional campaign management server 220 may store data records identifying time periods for when user device 210 was located within a particular range of longitude/latitude coordinates (e.g., coordinates corresponding to the location of a merchant facility or section of a merchant facility).

Process 700 may also include receiving campaign criteria (step 730). For example, as described above with respect to the campaign criteria module 420, the promotional campaign management server 220 may receive the campaign criteria as part of an instruction to establish a campaign with different active dates for different users. As described herein, the campaign criteria may include the campaign itself (e.g., an advertisement for discounts, a printable or electronic coupon, etc.), identification of a target audience (e.g., targeted vs. non-targeted shoppers, users in a particular demographic group, all users, etc.), and parameters that may be used to define different active time periods for a same campaign based on the location history of different user devices 210.

Process 700 may further include determining target user devices (step 740). For example, as described above with respect to the active time period determination module 430, the promotional campaign management server 220 may determine target user devices 210 associated with users in the targeted audience specified in the campaign criteria. For example, the promotional campaign management server 220 may store user profile information or each user device 210 that indicates attributes of the users, such as demographic information, an indication as to whether the user is a direct or non-direct shopper (e.g., based on social media information and/or other public information indicating the user's interest in shopping for a particular item), or the like. The promotional campaign management server 220 may map the target audience information from the campaign criteria to the user profile information to determine the targeted users and the corresponding user devices 210.

Process 700 may also include determining campaign active periods for each targeted user device (step 750). For example, as described above with respect to the active time period determination module 430, the promotional campaign management server 220 may determine campaign active periods for each targeted user device. The promotional campaign management server 220 may analyze the historical location data records for each user device 210 in the targeted audience, and determine the active time periods (subject to a minimum active time period if specified) for each user device 210 in the targeted audience based on the historical location data records.

Process 700 may further include providing notifications of the campaign to the user devices (step 760). For example, as described above with respect to the campaign notification module 440, the promotional campaign management server 220 may provide notifications of the campaign to the user devices 210. In embodiments, each notification to each individual user device 210 may identify the corresponding custom active time period.

FIGS. 8A and 8B show example graphs that may be used to determine custom active time periods of a campaign offered to different users. FIGS. 8A and 8B represent the amount of time different users spent in a merchant facility on different days. For example, the graph of FIG. 8A represents the amount of time the user “Person A” spent in a merchant facility on different days. As shown in FIG. 8A, the graph may be used to determine the campaign active time period given the campaign parameters with a day range from Monday-Friday and when zero minutes were spent in the merchant facility. For example, the campaign active time period may be determined to be Wednesday-Thursday since Wednesday-Thursday is within the day range of Monday-Friday and when the user spent zero minutes in the merchant facility.

Referring to FIG. 8B, the graph represent the amount of time the user “Person B” spent in the merchant facility on different days. Given the same parameters as previously discussed in FIG. 8A, the graph of FIG. 8B may be used to determine the campaign active time period as Monday-Wednesday. In embodiments, the graphs shown in FIGS. 8A and 8B may be generated based on the location records stored by the device monitoring module 410. In embodiments, the graphs may be provided for display to an administrator.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
receiving, by a computing device, user device location information for a plurality of user devices via a computer network;
storing, by the computing device, location history for the plurality of user devices corresponding to the user device location information;
receiving, by the computing device, campaign criteria in connection with offering a campaign to one or more of the plurality of user devices;
determining, by the computing device, active time periods for each the one or more of the plurality of user devices based on the stored location history for the one or more of the plurality of user devices and the campaign criteria, wherein the active time periods correspond to times period in which the campaign is active;
generating, by the computing device, and presenting a visual representation of the active time periods; and
providing, by the computing device, respective notifications regarding the campaign to each of the one or more of the plurality of user devices based on the determining the active time periods, wherein each of the respective notifications identify a respective active time period.

2. The method of claim 1, wherein the active time periods for each the one or more of the plurality of user devices are different.

3. The method of claim 1, wherein the campaign criteria is selected from the group consisting of:
a time or date range;
a minimum or maximum threshold amount of time spent in a merchant facility;
a minimum or maximum active time period;
a section of a merchant facility;
a targeted group of users.

4. The method of claim 1, further comprising determining the one or more of the plurality of user devices based on targeted users identified in the campaign criteria.

5. The method of claim 1, wherein at least one of the notification of the respective notifications includes a promotional advertisement, printable coupon, or an electronic coupon.

6. The method of claim 1, wherein at least one of the notifications of the respective notifications includes a pop-up notification, a text notification, or an e-mail notification.

7. The method of claim 1, further comprising:
generating a graph representing the location history for a particular user device of the plurality of user devices, and
determining an active time period for the particular user device of the plurality of user devices based on generating the graphs.

8. The method of claim 1, wherein the location history for the plurality of user devices identifies time periods when the plurality of user devices were located within a merchant facility or a section of the merchant facility.

9. The method of claim 1, wherein the user device location information is received from one or more location determination devices.

10. The method of claim 1, wherein a service provider at least one of creates, maintains, deploys and supports the computing device.

11. The method of claim 1, wherein steps of claim 1 are provided by a service provider on a subscription, advertising, or fee basis.

12. The method of claim 1, wherein the computing device includes software provided as a service in a cloud environment.

13. The method of claim 1, further comprising deploying a system for establishing different active periods for a single campaign offered to a plurality of users, comprising providing a computer infrastructure operable to perform the steps of claim 1.

14. A computer program product for establishing different active periods for a single campaign offered to a plurality of users, the computer program product comprising a computer readable storage medium having program instructions embodied therewith, the program instructions executable by a computing device to cause the computing device to:
monitor user device location information for a plurality of user devices while the plurality of user devices are located within a defined boundary;
determine location history for the plurality of user devices based on monitoring the user device location information;
receive campaign criteria in connection with offering a campaign to one or more of the plurality of user devices;
determine active time periods for each the one or more of the plurality of user devices based determining the location history for the one or more of the plurality of user devices and the campaign criteria, wherein the active time periods corresponds to time periods in which the campaign is active;
generate and present a visual representation of the active time periods; and
provide respective notifications regarding the campaign to each of the one or more of the plurality of user devices based on the determining the active time periods, wherein each of the respective notifications identify a respective active time period.

15. The computer program product of claim 14, wherein the active time periods for each the one or more of the plurality of user devices are different.

16. The computer program product of claim 14, wherein the campaign criteria includes all of:
a time or date range;
a minimum or maximum threshold amount of time spent in a merchant facility;
a minimum or maximum active time period;
a section of a merchant facility; and
a targeted group of users.

17. The computer program product of claim 14, wherein the program instructions further cause the computing device to:
generate a graph representing the location history for a particular user device of the plurality of user devices, and
determine an active time period for the particular user device of the plurality of user devices based on generating the graphs.

18. The computer program product of claim 14, wherein the user device location information is received from one or more location determination devices.

19. A system comprising:
a CPU, a computer readable memory and a computer readable storage medium associated with a computing device;
program instructions to monitor user device location information for a plurality of user devices while the plurality of user devices are located within a defined boundary;
program instructions to generate data records identifying the location history for the plurality of user devices based on monitoring the user device location information;
program instructions to receive campaign criteria in connection with offering a campaign to one or more of the plurality of user devices;
program instructions to determine active time periods for each the one or more of the plurality of user devices based on the data records identifying the location history for the one or more of the plurality of user devices and the campaign criteria, wherein the active time periods correspond to time periods in which the campaign is active;
program instructions to generate and present a visual representation of the active time periods; and
program instructions to providing respective notifications regarding the campaign to each of the one or more of the plurality of user devices based on the determining the active time periods, wherein each of the respective notifications identify a respective active time period,
wherein the program instructions are stored on the computer readable storage medium for execution by the CPU via the computer readable memory.

20. The system of claim 19, wherein the active time periods for each the one or more of the plurality of user devices are different.
